(19) United States
(12) Patent Application Publication
(10) Pub. No.: US 2026/0127711 A1
(43) Pub. Date: May 7, 2026

(54) MULTI-CAMERA PROCESSING IN EXTENDED REALITY (XR) SYSTEMS

(71) Applicant: QUALCOMM Incorporated, San Diego, CA (US)

(72) Inventors: Saurabh Ramesh GANGURDE, Bangalore (IN); Prasant Shekhar SINGH, Bangalore (IN); Amrit Anand AMRESH, Bangalore (IN); Shrey Shailesh GADIYA, Bengaluru (IN); Saurabh AGGARWAL, Bengaluru (IN); Abhijeet DEY, Bengaluru (IN); Varun BANSAL, New Delhi (IN)

(21) Appl. No.: 18/938,217

(22) Filed: Nov. 5, 2024

(51) Int. Cl. G06T 5/50; G06T 1/20; G06T 7/55

(52) U.S. Cl. CPC G06T 5/50; G06T 1/20; G06T 7/55; G06T 2207/20221

(57) ABSTRACT

Systems and techniques are described for image processing. For example, a computing device can receive a first frame of a first view of a scene and a second frame of a second view of the scene. The computing device can determine a first portion of the second frame that corresponds to a portion of the first frame. The computing device can process the first frame and output the processed first frame. The computing device can process a second portion of the second frame that is different from the first portion of the second frame. The computing device can output a composite frame based on the processed second portion of the second frame and the portion of the first frame.

### FIELD

The present disclosure generally relates to image processing. For example, aspects of the present disclosure relate to a visual see through (VST) solution in extended reality (XR) devices.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto images of a real-world environment, which can be viewed by a user through an XR device (e.g., a head-mounted display (HMD), extended reality glasses, or other device). For example, an XR device can display an environment to a user. In some cases, the environment may be at least partially different from the real-world environment in which the user is in. In some cases, such as in certain visual see-through (VST) systems or modes, the environment may be the same as the real-world environment in which the user is in. The user can generally change their view of the environment interactively, for example by tilting or moving the XR device (e.g., the HMD or other device).

An XR system can include a “see-through” display that allows the user to see their real-world environment based on light from the real-world environment passing through the display. In some cases, an XR system can include a “pass-through” display that allows the user to see their real-world environment, or a virtual environment based on their real-world environment, based on a view of the environment being captured by one or more cameras and displayed on the display. “See-through” or “pass-through” XR systems can be worn by users while the users are engaged in activities in their real-world environment.

In some cases, XR systems may be used to enhance experiences, such as for telepresence, gaming, metaverse, etc. Such technologies may allow a person to perform actions and/or have experiences, such as a collaborative and/or interactive experience with other persons, at a remote and/or virtual locations. In some cases, users may be represented in a virtual space as an animated avatar which may mimic movements and/or expressions of their representative user. A particular user may view the remote/virtual locations from a perspective of the avatar, for example, via an XR display device, such as a head mounted display (HMD) or mobile device. A precise reconstruction of a user's face for the avatar may allow for a more seamless, high quality, experience. In some cases, techniques for mesh estimation using HMD images may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described wherein for image processing. In some aspects, an apparatus for image processing is provided. The apparatus includes at least one memory and at least one processor coupled to the at least one memory and configured to: receive a first frame of a first view of a scene and a second frame of a second view of the scene; determine a first portion of the second frame that corresponds to a portion of the first frame; process the first frame; output the processed first frame; process a second portion of the second frame that is different from the first portion of the second frame; and output a composite frame based on the processed second portion of the second frame and the portion of the first frame.

In some aspects, a method for image processing is provided. The method includes: receiving a first frame of a first view of a scene and a second frame of a second view of the scene; determining a first portion of the second frame that corresponds to a portion of the first frame; processing the first frame; outputting the processed first frame; processing a second portion of the second frame that is different from the first portion of the second frame; and outputting a composite frame based on the processed second portion of the second frame and the portion of the first frame.

In some aspects, a non-transitory computer-readable medium having stored thereon instructions that, when executed by at least one processor, cause the at least one processor to: receive a first frame of a first view of a scene and a second frame of a second view of the scene; determine a first portion of the second frame that corresponds to a portion of the first frame; process the first frame; output the processed first frame; process a second portion of the second frame that is different from the first portion of the second frame; and output a composite frame based on the processed second portion of the second frame and the portion of the first frame.

In some aspects, an apparatus for image processing is provided. The apparatus includes: means for receiving a first frame of a first view of a scene and a second frame of a second view of the scene; means for determining a first portion of the second frame that corresponds to a portion of the first frame; means for processing the first frame; means for outputting the processed first frame; means for processing a second portion of the second frame that is different from the first portion of the second frame; and means for outputting a composite frame based on the processed second portion of the second frame and the portion of the first frame.

In some aspects, one or more of the apparatuses described herein is, can be part of, or can include an extended reality (XR) device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a vehicle (or a computing device, system, or component of a vehicle), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with some aspects of the disclosure.

FIG. 2 is a diagram illustrating an architecture of an example extended reality (XR) system, in accordance with some aspects of the disclosure.

FIG. 3 is a block diagram illustrating an example of interactions between components of an image capture and processing system, in accordance with some aspects of the disclosure.

FIG. 4 is a block diagram illustrating an example of data flow in a camera system, in accordance with some aspects of the disclosure.

FIG. 5 is a diagram illustrating an example of a system for visual see through (VST) use case, in accordance with some aspects of the disclosure.

FIG. 6A is a diagram illustrating examples of a first frame and a second frame that include portions with overlapping content and include portions with occlusions, in accordance with some aspects of the disclosure.

FIG. 6B is a diagram illustrating an illustrative example of determining an overlap ratio with respect to distance, in accordance with some aspects of the disclosure.

FIG. 7 is a diagram illustrating an example of a system for a VST solution, in accordance with some aspects of the disclosure.

FIG. 8 is a diagram illustrating an example of a process for a VST solution, in accordance with some aspects of the disclosure.

FIG. 9 is a diagram illustrating an example of operation of the system of FIG. 7 for a VST solution, where a portion including one or more objects in the background of a scene can be reused from a first frame for a second frame, in accordance with some aspects of the disclosure.

FIG. 10 is a diagram illustrating an example of operation of the system of FIG. 7 for a low power VST solution using redundancy in XR, where small areas surrounding portions including objects in the foreground are processed due to occlusion, in accordance with some aspects of the disclosure.

FIG. 11 is a diagram illustrating examples of portions a first frame and a second frame that are processed or reused, in accordance with some aspects of the disclosure.

FIG. 12 is a diagram illustrating examples of graphs showing a reduction in bandwidth and power savings by a system with two image post ends employing a VST solution, in accordance with some aspects of the disclosure.

FIG. 13 is a diagram illustrating examples of graphs showing a reduction in bandwidth, power, and latency by a system with a single image post end employing a VST solution, in accordance with some aspects of the disclosure.

FIG. 14 is a flow diagram illustrating an example of a process for image processing, in accordance with some aspects of the disclosure.

FIG. 15 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera (e.g., image capture device) is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor

Degrees of freedom (DoF) refer to the number of basic ways a rigid object can move through three-dimensional (3D) space. In some cases, six different DoF can be tracked. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as pitch, yaw, and roll.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

In some cases, an XR system may include an HMD display, such as AR HMD or AR glasses, that may be worn by a user of the XR system. Generally, it is desirable to keep an HMD display as light and small as possible. To help reduce the weight and the size of an HMD display, the HMD display may be a relatively lower power system (e.g., in terms of battery and computational power) as compared to a device (e.g., a companion device, such as a mobile phone, a server device, or other device) with which the HMD display is connected (e.g., via a wired or wireless connected).

Visual see through (VST) use cases for a stereo display (e.g., an HMD display) requires the capture of both a left eye view and a right eye view, and requires a related camera pipeline processing. Most of the right eye frame (e.g., captured by a right eye image sensor, of the HMD, with the right eye view) and the left eye frame (e.g., captured by a left eye image sensor, of the HMD, with the left eye view) has overlapping content. In current dataflows, a lot of redundant image post end (IPE) processing is occurring, which leads to increased costs in computation, power, and latency.

As such, improved systems and techniques for avoiding redundant computation in VST use cases can be beneficial to reduce computation, power, and latency costs.

In one or more aspects of the present disclosure, systems, apparatuses, methods (also referred to as processes), and computer-readable media (collectively referred to herein as “systems and techniques”) are described herein that provide solutions for a VST solution in XR systems (e.g., a low power VST solution using redundancy in XR).

Various aspects relate generally to image processing. Some aspects more specifically relate to systems and techniques that provide solutions that minimize camera processing by identifying overlapping portions or areas (and in some cases unoccluded portions) of each frame, and transform the processed overlapping content (and in some cases the unoccluded portions) from one view (e.g., a left eye view) for use in the other view (e.g., a right eye view). Content outside of an overlapping portion or area between frames can be considered occluded. Portions or areas within an overlapping portion or area can be determined as occluded or unoccluded. Further, the overlapping portions for reuse can be guided based on depth values. For example, small objects with variations in depth may be slightly occluded in one view (e.g., the right eye view) as compared to the other (e.g., the left eye view), and such regions with different depth values may be filtered out of the overlapping portions for reuse. In this way, power and latency can be reduced as compared to solutions requiring full processing of each camera pipeline (e.g., a left eye image sensor pipeline and a right eye image sensor pipeline).

In one or more aspects, during operation of a method for image processing, one or more processors of a device (e.g., an XR device) can receive a first frame of a first view (e.g., a left eye view) and a second frame of a second view (e.g., a right eye view) of the scene. The one or more processors can determine a first portion of the second frame that corresponds to a portion of the first frame (e.g., the first portion of the second frame overlaps with the portion of the first frame). For instance, to determine the first portion of the second frame that corresponds to the portion of the first frame, the one or more processors can determine (e.g., based on a depth of the scene) that the first portion of the second frame overlaps with the portion of the first frame. The one or more processors can process the first frame and can output the processed first frame (e.g., for storage, for further processing, for output via a display, etc.). The one or more processors can process a second portion (e.g., a non-overlapping or occluded portion) of the second frame that is different from the first portion of the second frame. The one or more processors can output a composite frame based on the processed second portion of the second frame and the portion of the first frame. For instance, the composite frame can be used for output instead of processing the full second frame due to the second frame having overlapping content with the first frame.

In some cases, the one or more processors can transform the portion of the first frame to the second view corresponding to the second frame to generate a transformed portion of the first frame. In such cases, the one or more processors can generate the composite frame based on the processed second portion of the second frame and the transformed portion of the first frame.

In some aspects, the one or more processors can determine a depth of a portion of the scene based on the first frame and the second frame. In some cases, the portion of the scene includes one or more objects within the scene. The one or more processors can determine the portion of the scene is unoccluded in the first frame (e.g., present, or overlapping, in both the first frame and the second frame) based on the first frame, the second frame, and the depth of the portion of the scene. Based on determining the portion of the scene is unoccluded in the first frame, the one or more processors can transform the portion of the scene from the first frame to the second view corresponding to the second frame to generate a transformed portion of the first frame. The one or more processors can generate the composite frame based on the processed second portion of the second frame and the transformed portion of the first frame. In some cases, the one or more processors can determine the depth of the portion of the scene further based on time of flight data and/or depth sensor data. In some cases, the one or more processors can transform the portion of the scene from the first frame to the second view corresponding to the second frame based on the depth of the portion of the scene and/or using a machine learning system.

In one or more examples, a first image sensor, with the first view of the scene, can obtain (e.g., capture) the first frame of the scene. In some examples, a second image sensor, with a second view of the scene, can obtain (e.g., capture) the second frame of the scene. In one or more examples, the first image sensor is a left eye image sensor of an extended reality (XR) headset, and the second image sensor is a right eye image sensor of the XR headset. In some cases, processing the first frame and processing the second portion of the second frame can be performed by an image signal processor (ISP). In some examples, the one or more processors can process the processed first frame (e.g., after outputting the processed first frame, such as from the ISP) and the composite frame using a graphics processing unit (GPU). In one or more examples, the composite view of the scene can be a stereo view of the scene.

Particular aspects of the subject matter described in this disclosure can be implemented to realize one or more of the following potential advantages. In one or more examples, the systems and techniques can provide a benefit of improving power and latency for VST use cases in XR by determining overlapping (and in some cases unoccluded) regions or portions using depth information to avoid repetitive computation. In some examples, the systems and techniques can provide a benefit of enabling higher device usage time for the same system configuration. In one or more examples, the systems and techniques can provide a benefit of enabling higher processing resolution without requiring an increase in power.

Additional aspects of the present disclosure are described in more detail below.

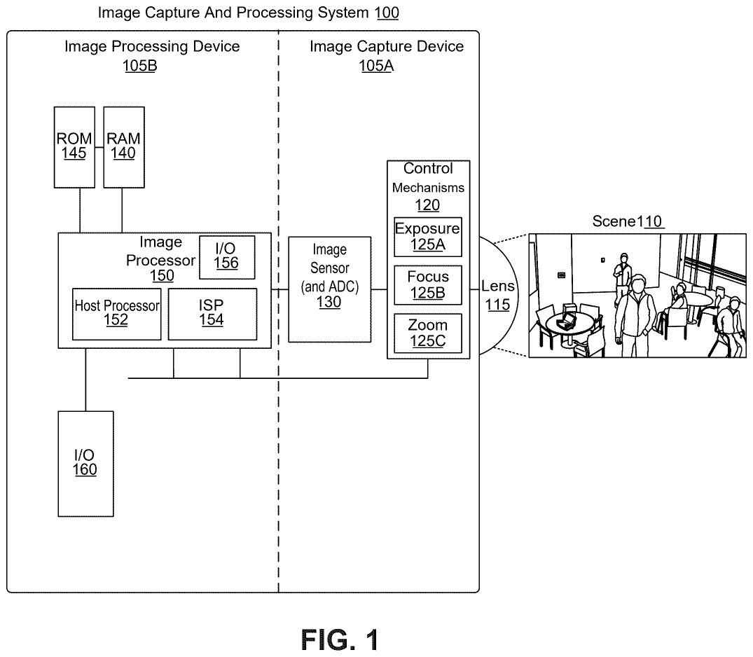

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

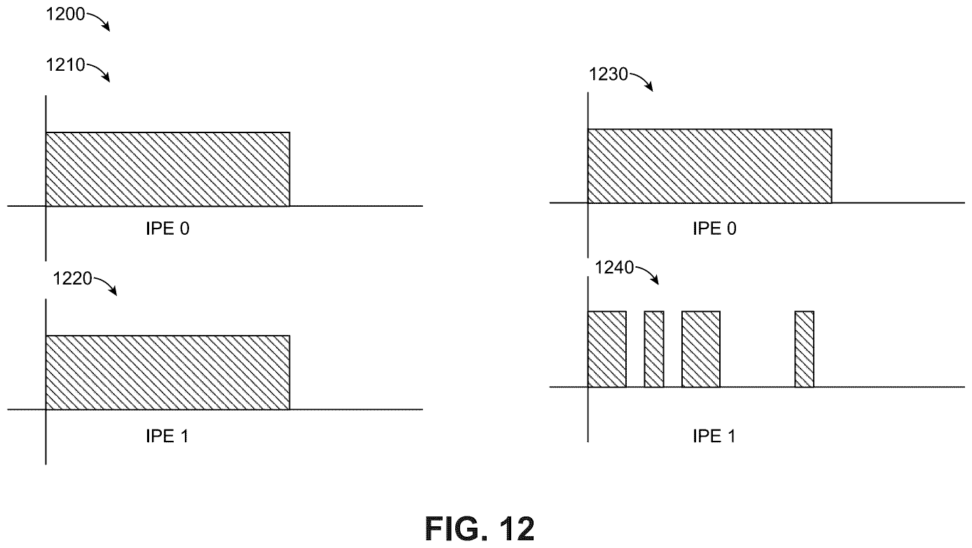

The image processor 150 may include one or more processors, such as one or more image signal processors (ISPs) (including ISP 154), one or more host processors (including host processor 152), and/or one or more of any other type of processor 1210 discussed with respect to the computing system 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

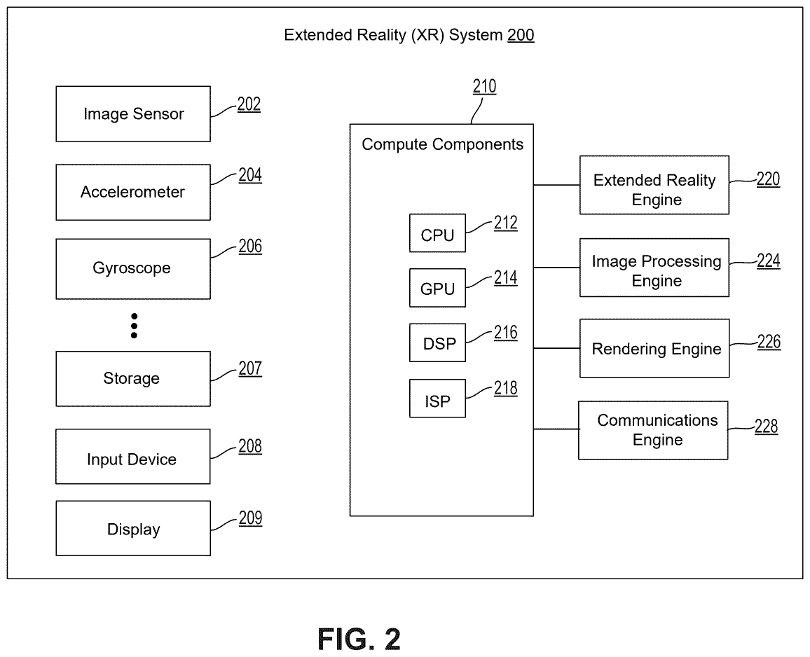

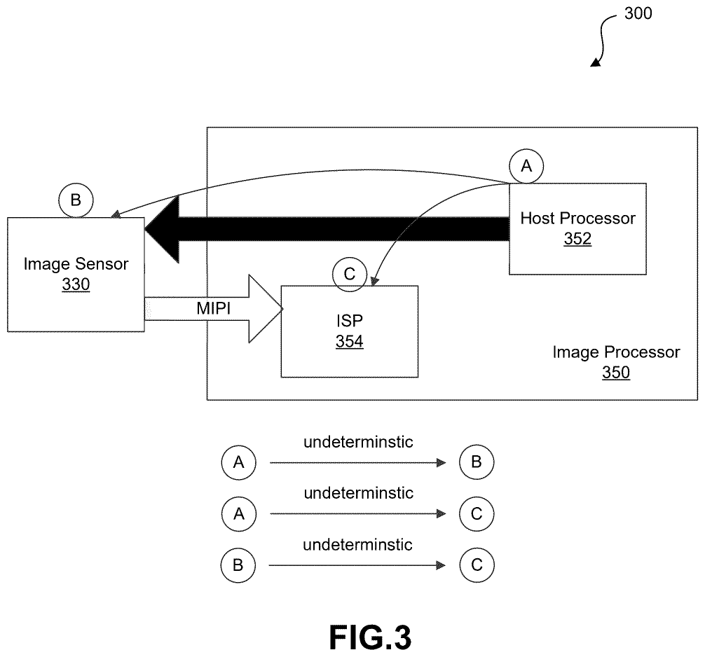

In some examples, the extended reality (XR) system 200 of FIG. 2 can include the image capture and processing system 100, the image capture device 105A, the image processing device 105B, or a combination thereof. In some examples, the simultaneous localization and mapping (SLAM) system 300 of FIG. 3 can include the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1045 discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1240 of FIG. 12.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown), such as the SLAM system 300 of FIG. 3. SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

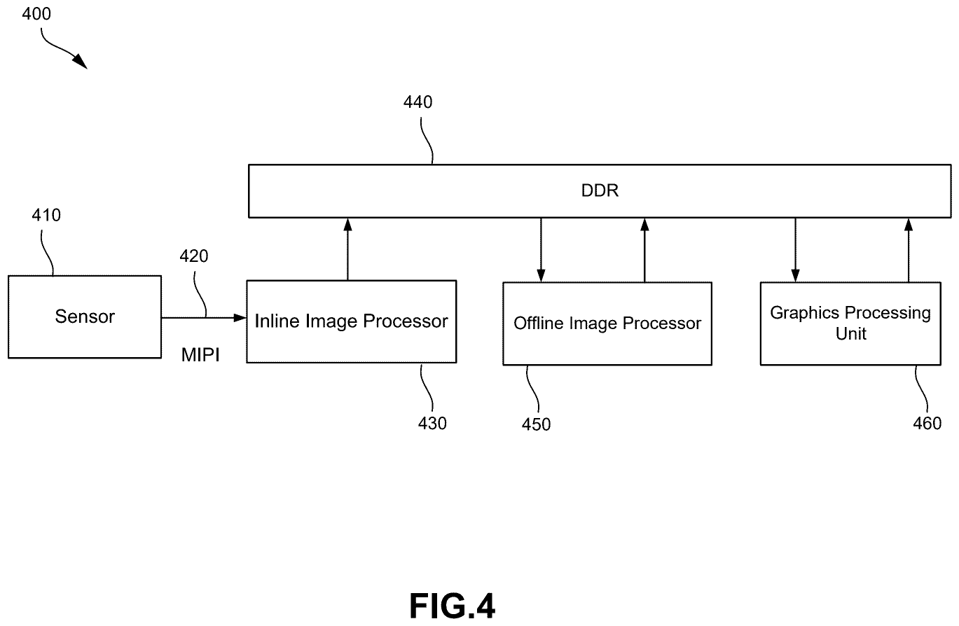

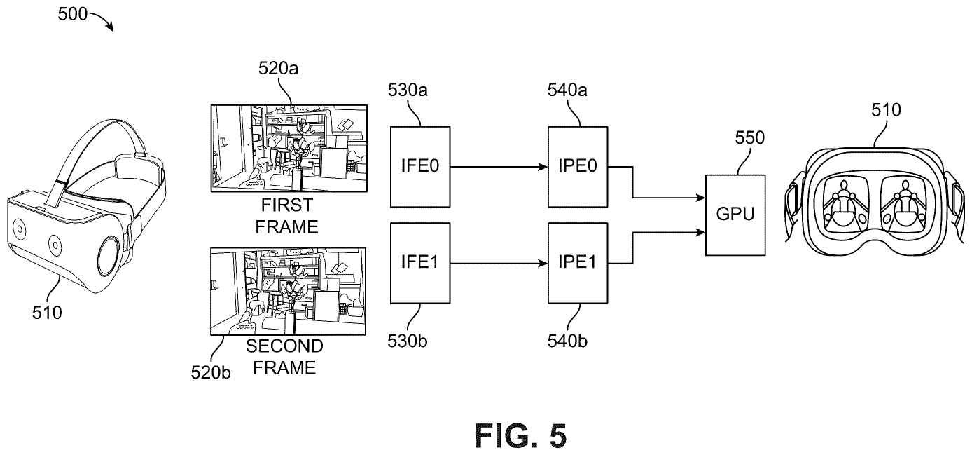

As one illustrative example, the compute components 210 can extract feature points corresponding to a mobile device (e.g., mobile device 440 of FIG. 4, mobile device 540 of FIG. 5), or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

Synchronization between an image sensor (e.g., the image sensor 130 of FIG. 1) and an ISP (e.g., the ISP 154 of FIG. 1) is important in order to provide an operational image capture system that generates high quality images without interruption and/or failure. FIG. 3 is a block diagram illustrating an example of an image capture and processing system 300 including an image processor 350 (including host processor 352 and ISP 354) in communication with an image sensor 330. The configuration shown in FIG. 3 is illustrative of traditional synchronization techniques used in camera systems. In general, the host processor 352 attempts to provide synchronization between the image sensor 330 and the ISP 354 using fixed periods of time by separately communicating with the image sensor 330 and the ISP 354. For example, in traditional camera systems, the host processor 352 communicates with the image sensor 330 (e.g., over an I2C port) and programs the image sensor 330 parameters with a first fixed period of time, such as two-frame periods ahead of when that image frame will be processed by the ISP 354. The host processor 352 communicates with the ISP 354 (e.g., over an internal AHB bus or other interface) and programs the ISP 354 parameter settings with a second fixed period of time, such as 1-frame period ahead of when that image frame will be processed by the ISP 354.

The image sensor 330 can send image frames to the ISP 354 (B-to-C in FIG. 3), such as over an MIPI CSI-2 PHY port or interface, or other suitable interface. However, the communication between the host processor 352 and the image sensor 330 (shown as from A to B) is undeterministic. Similarly, the communication between the image sensor 330 and the ISP 354 (shown as from B to C) and the communication the host processor 352 and the ISP 354 (shown as from A to C) are also undeterministic. For example, there can be varying latencies in programming of the image sensor 330 and the ISP 354 by the host processor 352, which can result in a parameter settings mismatch between the sensor and the ISP. The latencies can be due to high CPU usage, congestion in one or more I/O ports, and/or due to other factors.

FIG. 4 is a block diagram illustrating an example of data flow in a camera system. In particular, FIG. 4 is a diagram illustrating an example of a system 400 for a camera showing the data flow. In FIG. 4, the system 400 is shown to include a sensor 410 (e.g., a camera sensor subsystem for obtaining image frames capturing scenes), an inline image processor 430 (e.g., image front end (IFE)), an offline image processor 450 (e.g., also referred to as an offline processing engine or image processing engine (IPE)), and a graphics processing unit (GPU) 460. The sensor 410, the inline image processor 430, the offline image processor 450, and the GPU 460 are all shown to be in communication with DDR memory 440.

During operation of the system 400, the sensor 410 can stream pixels of sensor data to the inline image processor 430 (e.g., an image front-end camera component, which can be a component in a system on a chip (SOC)) via a Mobile Industry Processor Interface (MIPI) 420. After the inline image processor 430 receives the pixels from the sensor 410, the inline image processor 430 can process the pixels (e.g., by processing the pixels one line at a time). After the inline image processor 430 has processed one or more of the lines of the image frame, the inline image processor 430 can transfer the processed sensor data to the DDR memory 440. The offline image processor 450 can read the image frames from the DDR memory 440. The processing by the inline image processor 430 is referred to as inline processing because the inline image processor 430 processes the pixels in line with the operation of the sensor 410 (e.g., as the pixels are received from the sensor 410 via the MIPI 420).

The timing of the inline image processor 430 may need to be strictly maintained because the timeline of operation of the inline image processor 430 needs to correspond to (e.g., be inline with) the timeline of operation of the sensor 410. As such, if the sensor 410 readout occurs within 8.3 milliseconds, the operation of the inline image processor 430 can also be within 8.3 milliseconds to finish processing all of the pixels it receives from the sensor 410 to be completely inline.

As previously mentioned, an XR system can include an optical “see-through” or “pass-through” display (e.g., see-through AR HMD or glasses), allowing the XR system to display XR content (e.g., AR content) directly onto a real-world view without displaying video content. The see-through display can allow the user to see a real-world or physical object directly. The see-through display can display an enhanced image of that object (or additional AR content) to augment the user's visual perception of the real world.

Visual see through (VST) use cases for a stereo display (e.g., an HMD or glasses display) requires the capture of both a left eye view and a right eye view, and a related camera pipeline processing. FIG. 5 is a diagram illustrating an example of a system 500 for VST use case. In FIG. 5, the system 500 is shown to include an HMD device 510, a first image front end (IFE0) 530a of an image signal processor (ISP), a second image front end (IFE1) 530b of the ISP, a first image post end (IPE0) 540a of the ISP, a second image post end (IPE1) 540b of the ISP, and a graphics processing unit (GPU) 550. In one or more examples, the system 500 may include more or less and/or at least some different types of components than as shown in FIG. 5.

Typically, for an XR use case, an HMD device (e.g., HMD device 510) or glasses will have two image sensors (e.g., cameras) to capture a scene in front on the HMD device or glasses. One of the image sensors (e.g., a first image sensor) will be a left eye image sensor, and the other image sensor (e.g., a second image sensor) will be a right eye image sensor. In FIG. 5, the first image sensor (e.g., with a first field of view of a scene) of the HMD device 510 is shown to capture a first frame 520a (e.g., an image frame), and the second image sensor (e.g., with a second field of view of the scene) of the HMD device 510 is shown to capture a second frame 520b (e.g., an image frame).

After the first frame 520a is captured, the first image front end (IFE0) 530a can process the first frame 520a to generate a first image front end output, which can be input into the first image post end (IPE0) 540a. The first image post end (IPE0) 540a can then process the first image front end output to generate a first image post end output, which can be input into the GPU 550.

Similarly, after the second frame 520b is captured, the second image front end (IFE1) 530b can process the second frame 520b to generate a second image front end output, which can be input into the second image post end (IPE1) 540b. The second image post end (IPE1) 540b can then process the second image front end output to generate a second image post end output, which can be input into the GPU 550. As such, the processing of the first frame 520a and the second frame 520b occurs in two separate processing pipelines of the system 500. In one or more examples, the processing of the first frame 520a and the second frame 520b in these two processing pipelines may be performed in parallel.

The GPU 550 can then process the first image post end output and the second image post end output to generate a composite view (e.g., a stereo view) of the scene. In one or more examples, the composite view of the scene can be displayed on a first display (e.g., a left eye display) and a second display (e.g., a right eye display) of the HMD device 510.

Typically, most of the right eye frame (e.g., a first frame, such as the first frame 520a, captured by a right eye image sensor, of the HMD or glasses, with the right eye view) and the left eye frame (e.g., a second frame, such as the second frame 520b, captured by a left eye image sensor, of the HMD or glasses, with the left eye view) has overlapping content (e.g., duplicate content). In current dataflows, a large amount of redundant image post end (IPE) processing is occurring (e.g., in both of the two processing pipelines), which results in increased computation, power, and latency.

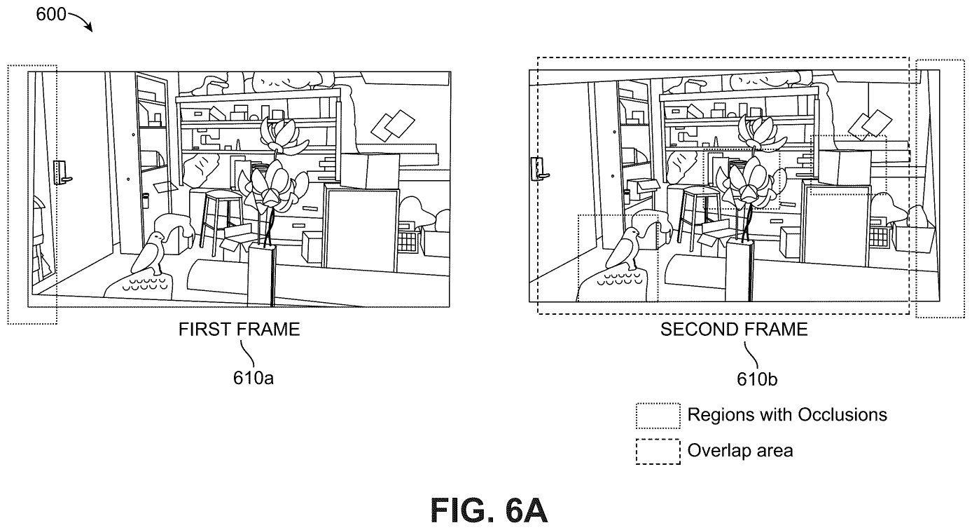

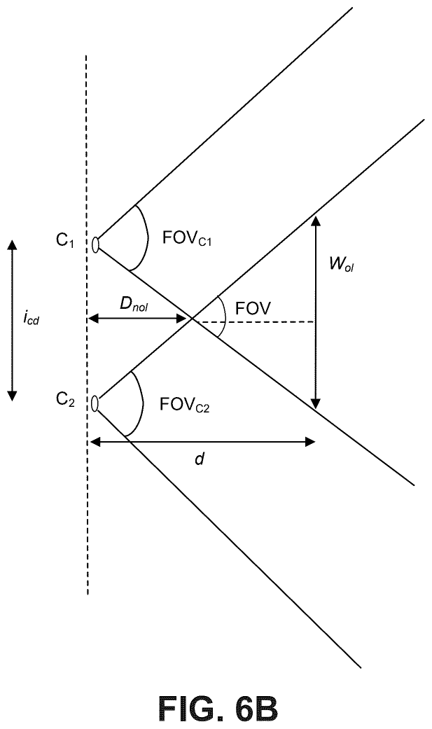

FIG. 6A shows examples of overlapping content in frames. In particular, FIG. 6A is a diagram illustrating examples 600 of a first frame 610a (e.g., with a first view of a scene) and a second frame 610b (e.g., with a second view of the scene) that include portions with overlapping content (and in some cases unoccluded content) and include portions with occlusions (e.g., occluded content). For example, in FIG. 6A, the second frame 610b is shown to include a portion (e.g., a region) with an overlap area. This portion with the overlap area (e.g., which mostly includes the background of the scene) includes one or more objects that are within view in both the first frame 610a and the second frame 610b.

In FIG. 6A, the first frame 610a is also shown to include one portion (e.g., region) with occlusions. This portion includes one or more objects that are not within view of the second frame 610b. FIG. 6A also shows that the second frame 610b includes four portions (e.g., regions) with occlusions. These four portions each include one or more objects that are not within view of the first frame 610a.

Redundant processing of the overlapping areas in the two frames can lead to increased costs in computation, power, and latency. As such, improved systems and techniques for avoiding redundant computation in VST use cases can be useful to reduce computation, power, and latency costs.

In one or more aspects, the systems and techniques provide solutions for VST solution in XR. In one or more examples, the systems and techniques provide solutions that can minimize camera processing by identifying overlapping portions (and in some cases unoccluded content) of each frame, and transforming the processed overlapping content from one view (e.g., a left eye view) for use (e.g., for reuse) in the other view (e.g., a right eye view). As noted previously, in some cases, content outside of an overlapping portion or area between frames can be considered occluded. Portions or areas within an overlapping portion or area can be determined as occluded or unoccluded. As such, power and latency can be reduced as compared to solutions that perform full processing of each camera pipeline (e.g., a left eye image sensor pipeline and a right eye image sensor pipeline).

In some aspects, the systems and techniques can predict or estimate (or make a predictive estimation) of an overlap region (e.g., portion or area) between two images or frames (or views) of a scene (e.g., between a left eye view and a right eye view, such as corresponding to two stereo images). For instance, an object of lower depth (e.g., corresponding to a distance of the object from the camera) will have a lesser overlap in the two stereo images (e.g., a left eye view and a right eye view), and an object of higher depth will have more overlap in the two stereo images.

According to various aspects, the systems and techniques can model estimated overlap between two frames of a scene (e.g., stereo images, such as a left eye view and a right eye view) as a function of weighted Lp-norm of a depth map of the scene. In some cases, one or more weights can depend on the proximity of depth map pixel to a portion of the frame (e.g., gaze/fovea center) and p can be set to any suitable value. In some examples, the weights can be constant or can be inversely proportional to the distance from object of interest (if any) or to the portion of the frame (e.g., the gaze/fovea center). In one illustrative example, the function ƒ can be modelled using a piecewise linear (PWL) function by proper calibration, such as using the following:

$$overlap = f ( {( \frac{{\sum }_{i , j} w ( i , j ) {d ( i , j )}^{p}}{{\sum }_{i , j} w ( i , j )} )}^{1 / p} ) \qquad Equation ( 1 )$$

In some aspects, instead of p norm, the systems and techniques can use a PWL based on individual depth pixel values, such as using the following as:

$$overlap = f ( \frac{{\sum }_{i , j} w ( i , j ) g ( d ( i , j ) )}{{\sum }_{i , j} w ( i , j )} ) \qquad Equation ( 2 )$$

In some aspects, the systems and techniques can use a machine learning system (e.g., a neural network) that can process a depth map to determine an overlap measure (e.g., indicating an amount of overlap between frames).

In some examples, the overlap estimation techniques can be made predictive by incorporating motion information for previous frames.

FIG. 6B is a diagram illustrating an illustrative example of determining an overlap ratio between frames/images with respect to depth/distance. In such an example, the term i_{cd} can denote the distance between two cameras (denoted as C₁ and C₂), ∠fov can denote the fovea field of view (FOV) angle (e.g., assuming fovea is centered), d can denote the depth (or distance) of an object from the cameras' center along a center axis, Dₙₒₗ can denote a distance up until which an object would not be present in the fovea FOV (e.g., after which the object becomes visible in the fovea FOV), Wₒₗ can denote a width of the overlap at depth (or distance) d, and W_{fov} can denote the width of the fovea FOV at distance d. Using such notation, the following formulation can be used to determine (e.g., estimate) an overlap ratio between two frames or images (e.g., stereo images, such as a left eye view and a right eye view):

$${D}_{nol} = \frac{{i}_{cd}}{2} * cot ( \frac{fov}{2} ) \qquad Equation ( 3 )$$

$${W}_{fov} = 2 d * tan ( \frac{fov}{2} ) \qquad Equation ( 4 )$$

$${W}_{ol} = 2 * ( d - {D}_{ol} ) * tan ( \frac{fov}{2} ) \qquad Equation ( 5 )$$

$$= 2 d * tan ( \frac{fov}{2} ) - 2 {D}_{ol} * tan ( \frac{fov}{2} ) \qquad Equation ( 6 )$$

$$= 2 d * tan ( \frac{fov}{2} ) - {i}_{cd} \qquad Equation ( 7 )$$

$$overlap ratio = \frac{{W}_{ol}}{{W}_{fov}} = ( 1 - \frac{{D}_{nol}}{d} ) \qquad Equation ( 8 )$$

Such a result approaches 1 as the depth/distance d increases, signifying that with increase in depth/distance, overlap will increase. In some examples, the systems and techniques can model the overlap ratio as a function of depth map as mentioned above. In one illustrative example, assuming fovea fov=300 and i_{cd}=0.06 m, then Dₒₗ=0.12 m. For d=1 m, the Overlap ratio=88%, which can provide significant bandwidth, power, and/or memory efficiency. For instance, for a 36 Megapixel (36MP) sensor with ⅓ by ⅓ fovea of 4MP, the savings can be determined as 4MP*0.44=1.76 MP per eye camera (corresponding to 15.6% of total bandwidth of both cameras). As a scene can include multiple objects with different depths (or distances) d, the above equations can be used to aggregate and obtain an estimate of an overlap area window between frames (e.g., the overlap area in FIG. 6A). Equation (8) above used to determine the Overlap ratio provide an example of the PWL g(.) used in Equation (2).

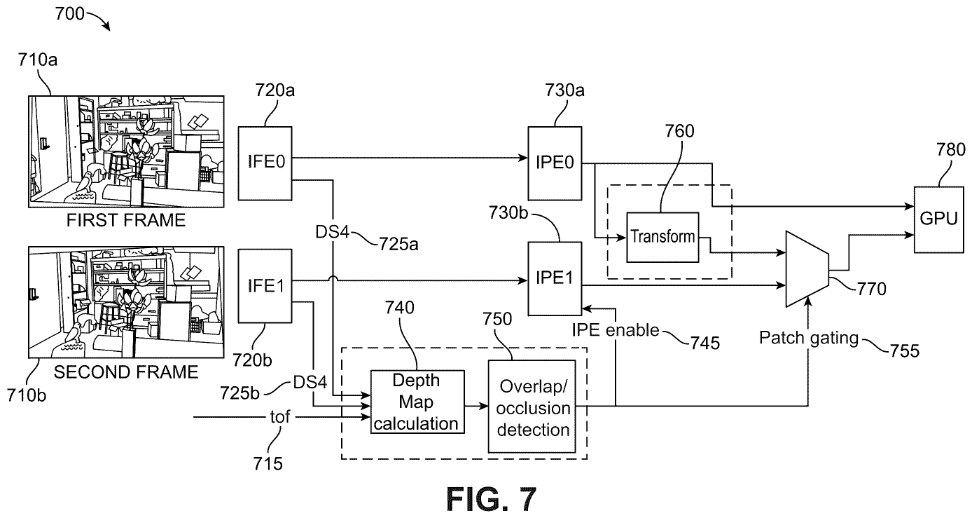

FIG. 7 shows an example of a system 700 for a VST solution in XR (e.g., a low power VST solution using redundancy in XR). In one or more examples, the system 700 may be employed within a device, such as an XR headset or HMD. In FIG. 7, the system 700 is shown to include a first image front end (IFE0) 720a of an ISP, a second image front end (IFE1) 720b of the ISP, a first double data rate (DDR) 725a (e.g., a DR4), a second DDR 725b (e.g., a DR4), a depth map calculation engine 740, an overlap/occlusion detection engine 750, a first image post end (IPE0) 730a of the ISP, a second image post end (IPE1) 730b of the ISP, a transform engine 760, a multiplexer 770, and a GPU 780.

In one or more examples, a first image sensor of the device, with a first view (e.g., a left eye view) of a scene, can obtain (e.g., capture) a first frame 710a (e.g., image frame) of the scene. A second image sensor, with a second view (e.g., a right eye view) of the scene, can obtain (e.g., capture) a second frame 710b (e.g., image frame) of the scene. In one or more examples, the first image sensor is a left eye image sensor of the device (e.g., XR headset or HMD), and the second image sensor is a right eye image sensor of the device.

In one or more examples, during operation of the system 700, the first image front end (IFE0) 720a can process the first frame 710a of the first view of the scene to generate a first image front end output, which can be input into the first image post end (IPE0) 730a. The first image post end (IPE0) 730a can process the first image front end output to generate a first image post end output (e.g., a processed first frame, also referred to as a first view output), which can be input into the GPU 780 for processing.

In some examples, the first image post end output can be input into the transform engine 760 (e.g., including one or more processors). One or more processors (e.g., of the transform engine 760) can, based on the first image post end output, transform a portion of the scene from the first view corresponding to the first frame 710a to the second view corresponding to the second frame 710b to produce a transformed first view output, which can be input into the multiplexer 770 for selection. In one or more examples, transforming the portion of the scene from the first view corresponding to the first frame 710a to the second view corresponding to the second frame 710b can be based on a depth of the portion of the scene (e.g., determined by the depth map calculation engine 740) and/or artificial intelligence. In some examples, the portion of the scene includes one or more objects within the scene.

The second image front end (IFE1) 720b can process the second frame 710b of the second view of the scene to generate a second image front end output, which can be input into the second image post end (IPE1) 730b.

The first image front end output can be sent from the first image front end (IFE0) 720a to a depth map calculation engine 740 (e.g., including one or more processors) via the DDR 725a. Similarly, the second image front end output can be sent from the second image front end (IFE1) 720b to the depth map calculation engine 740 via the DDR 725b.

One or more processors (e.g., of the depth map calculation engine 740) can determine a depth of a portion (e.g., a region) of the scene based on the first image front end output (e.g., which is based on the first frame 710a) and the second image front end output (e.g., which is based on the second frame 710b). In some examples, determining the depth of the portion of the scene, by the one or more processors of the depth map calculation engine 740, can be further based on time of flight (ToF) data 715 and/or depth sensor data.

The determined depth of the portion of the scene can be input into the overlap/occlusion detection engine 750 (e.g., implemented by or including one or more processors). In some aspects, the overlap/occlusion detection engine 750 can utilize the equations (1)-(8) described above to determine overlap/occlusion between frames. One or more processors (e.g., implementing the overlap/occlusion detection engine 750) can determine whether the portion of the scene is present, or overlapping, in both the first frame 710a and the second frame 710b. For instance, the one or more processors can determine whether the portion of the scene is overlapping between the first frame 710a and the second frame 710b and/or whether the portion of the scene is occluded or unoccluded in the second frame 710b relative to the first frame 710a. As noted previously, content outside of an overlapping portion or area between the frames can be considered occluded. Portions or areas within an overlapping portion or area can be determined as occluded or unoccluded. In some cases, the one or more processors can determine whether the portion of the scene is overlapping between the first frame 710a and the second frame 710b and/or whether the portion of the scene is unoccluded in the first frame 710a based on the first image front end output (e.g., which is based on the first frame 710a), the second image front end output (e.g., which is based on the second frame 710b), and the determined depth of the portion of the scene.

If the one or more processors (e.g., implementing the overlap/occlusion detection engine 750) determine that the portion of the scene is present, or overlapping, in both the first frame 710a and the second frame 710b (e.g., overlapping between the first frame 710a and the second frame 710b and/or is unoccluded in the second frame 710b relative to the first frame 710a), the one or more processors can send a patch gating command 755 to the multiplexer 770 commanding the multiplexer 770 to select and output the transformed first frame (e.g., generated by the transform engine 760), also referred to as a transformed first view output. The one or more processors (e.g., the image front end (IFE1) 720b and/or the image post end (IPE1) 730b) can also process a portion of the second frame 710b that is not overlapping with the first frame 710a (or that is occluded with respect to the first frame 710a). The one or more processors can then combine the transformed first frame with the portion of the second frame 710b that is not overlapping with the first frame 710a (or that is occluded with respect to the first frame 710a) to generate a composite frame (e.g., a new version of the second frame 710b generated using the transformed portion of the first frame 710a). The composite frame can be input (e.g., as a second view output) into the GPU 780 (e.g., including one or more processors) for processing. The one or more processors (e.g., the GPU 780) can process the first view output (e.g., generated by the first image post end (IPE0) 730a) and the composite frame to generate a composite view of the scene. In one or more examples, the composite view of the scene can be a stereo view of the scene.

However, if the one or more processors (e.g., implementing the overlap/occlusion detection engine 750) determine that the portion of the scene is not overlapping between the first frame 710a and the second frame 710b and/or is occluded in the second frame 710b relative to the first frame 710a, the one or more processors can send an IPE enable command 745 to the second image post end (IPE1) 730b commanding the second image post end (IPE1) 730b to process the second image front end output (e.g., the entire second frame as processed and output by the second image front end (IFE1) 720b). After receiving the IPE enable command 745, the second image post end (IPE1) 730b can process the second image front end output to generate a second image post end output, which can be input into the multiplexer 770 for selection.

When the one or more processors (e.g., implementing the overlap/occlusion detection engine 750) determine that the portion of the scene is not overlapping between the first frame 710a and the second frame 710b and/or is occluded in the second frame 710b relative to the first frame 710a, the one or more processors can also send a patch gating command 755 to the multiplexer 770 commanding the multiplexer 770 to select and output the second image post end output, which can be input (e.g., as a second view output) into the GPU 780 (e.g., including one or more processors) for processing. One or more processors (e.g., the GPU 780) can process the first view output (e.g., generated by the first image post end (IPE0) 730a) and the second view output (e.g., generated by the second image post end (IPE1) 730b) to generate a composite view (e.g., a stereo view) of the scene.

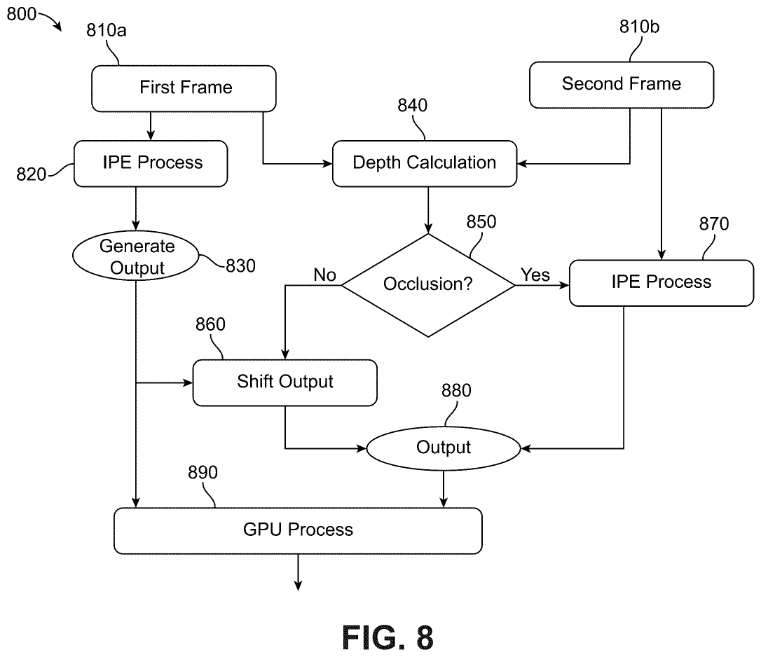

FIG. 8 is a diagram illustrating an example of a process 800 for a VST solution in XR. In one or more examples, during operation of the process 800 of FIG. 8, at block 820, an IPE (e.g., a first IPE) may process a first frame 810a (e.g., obtained by a first image sensor, of a device, with a first view of a scene) to generate an output 830.

At block 840, one or more processors (e.g., of a depth map calculation engine) may calculate, based on the first frame 810a and a second frame 810b (e.g., obtained by a second image sensor, of a device, with a second view of the scene), a depth of a portion (e.g., including one or more objects) of the scene. At decision block 850, one or more processors (e.g., of an occlusion detection engine) may determine whether the portion of the scene is overlapping in the first frame 810a and a second frame 810b and/or is occluded in one of the frames relative to the other (e.g., occluded in the second frame 810b relative to the first frame 810a).

If the one or more processors determine that the portion of the scene is not overlapping between the first frame 810a and the second frame 810b and/or is occluded in the second frame 810b relative to the first frame 810a, at block 870, an IPE (e.g., a second IPE) may process the second frame 810b to generate an output 880.

However, if the one or more processors determine that the portion of the scene is overlapping between the first frame 810a and the second frame 810b and/or is not occluded (e.g., unoccluded) in the second frame 810b relative to the first frame 810a, at block 860, one or more processors (e.g., of a transform engine) may transform (e.g., shift) the portion of the scene from the first view corresponding to the first frame 810a to the second view corresponding to the second frame 810b to generate a transformed portion of the first frame. For example, the one or more processors can transform the portion of the first frame 810a to the second view corresponding to the second frame 810b to generate a transformed portion of the first frame. An IPE (e.g., a second IPE) can also process a portion of the second frame 810b that is not overlapping with the first frame 810a (or that is occluded with respect to the first frame 810a). The one or more processors can combine the transformed portion of the first frame with the processed portion of the second frame 810b that is not overlapping with the first frame 810a (or that is occluded with respect to the first frame 810a) to generate the output 880, which can be referred to as a composite frame.

At block 890, one or more processors (e.g., of a GPU) can process the output 830 and the output 880 (e.g., the composite frame) to generate a composite view of the scene (e.g., a stereo view of the scene.

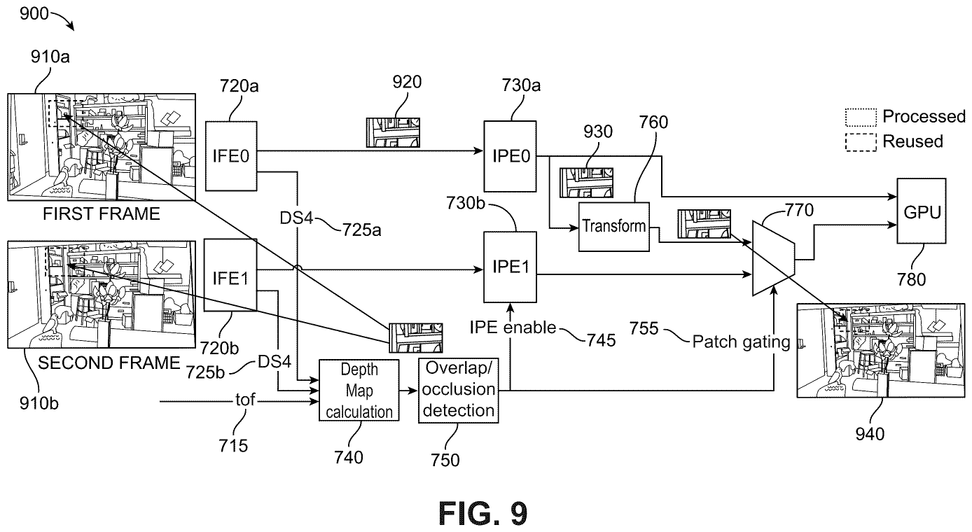

FIG. 9 is a diagram illustrating an example 900 of operation of the system 700 of FIG. 7 for a VST solution in XR, where a portion including one or more objects in the background of a scene can be reused from a first frame 910a for a second frame 910b.

In one or more examples, during operation of the system 700, the first image front end (IFE0) 720a can process the first frame 910a of the first view of the scene to generate a first image front end output 920, which can be input into the first image post end (IPE0) 730a. The first image post end (IPE0) 730a can process the first image front end output 920 to generate a first image post end output 930 (e.g., a processed first frame, also referred to as a first view output), which can be input into the GPU 780 for processing.

The first image post end output 930 can be input into the transform engine 760 (e.g., including one or more processors). One or more processors (e.g., of the transform engine 760) can, based on the first image post end output 930, transform a portion of the scene from the first view corresponding to the first frame 910a to the second view corresponding to the second frame 910b to produce a transformed first view output 940, which can be input into the multiplexer 770 for selection.

The second image front end (IFE1) 720b can process the second frame 910b of the second view of the scene to generate a second image front end output), which can be input into the second image post end (IPE1) 730b.

The first image front end output 920 can be sent from the first image front end (IFE0) 720a to a depth map calculation engine 740 (e.g., including one or more processors) via the DDR 725a. Similarly, the second image front end output can be sent from the second image front end (IFE1) 720b to the depth map calculation engine 740 via the DDR 725b.

One or more processors (e.g., of the depth map calculation engine 740) can determine a depth of a portion (e.g., a region) of the scene based on the first image front end output 920 (e.g., which is based on the first frame 710a) and the second image front end output (e.g., which is based on the second frame 710b).

The determined depth of the portion of the scene can be input into the overlap/occlusion detection engine 750 (e.g., including one or more processors). As noted previously, the overlap/occlusion detection engine 750 can utilize the equations (1)-(8) described above to determine overlap/occlusion between frames. One or more processors (e.g., implementing the overlap/occlusion detection engine 750) can determine whether the portion of the scene is present, or overlapping, in both the first frame 910a and the second frame 910b (e.g., whether the portion of the scene is overlapping between the first frame 910a and the second frame 910b and/or whether the portion of the scene is occluded or unoccluded in the second frame 910b relative to the first frame 910a), based on the first image front end output 920 (e.g., which is based on the first frame 910a), the second image front end output (e.g., which is based on the second frame 910b), and the determined depth of the portion of the scene.

If the one or more processors (e.g., implementing the overlap/occlusion detection engine 750) determine that the portion of the scene is present, or overlapping, in both the first frame 910a and the second frame 910b (e.g., overlapping between the first frame 910a and the second frame 910b and/or is unoccluded in the second frame 910b relative to the first frame 910a), the one or more processors can send a patch gating command 755 to the multiplexer 770 commanding the multiplexer 770 to select and output the transformed first frame 940 (e.g., generated by the transform engine 760), also referred to as a transformed first view output. The one or more processors (e.g., the image front end (IFE1) 720b and/or the image post end (IPE1) 730b) can also process a portion of the second frame 910b that is not overlapping with the first frame 910a (or that is occluded with respect to the first frame 910a). The one or more processors can then combine the transformed first frame 940 with the portion of the second frame 910b that is not overlapping with the first frame 910a (or that is occluded with respect to the first frame 910a) to generate a composite frame (e.g., a new version of the second frame 910b generated using the transformed portion of the first frame 7910a). The composite frame can be input (e.g., as a second view output) into the GPU 780 (e.g., including one or more processors) for processing. The one or more processors (e.g., the GPU 780) can process the first view output 930 (e.g., generated by the first image post end (IPE0) 730a) and the composite frame to generate a composite view (e.g., a stereo view) of the scene.

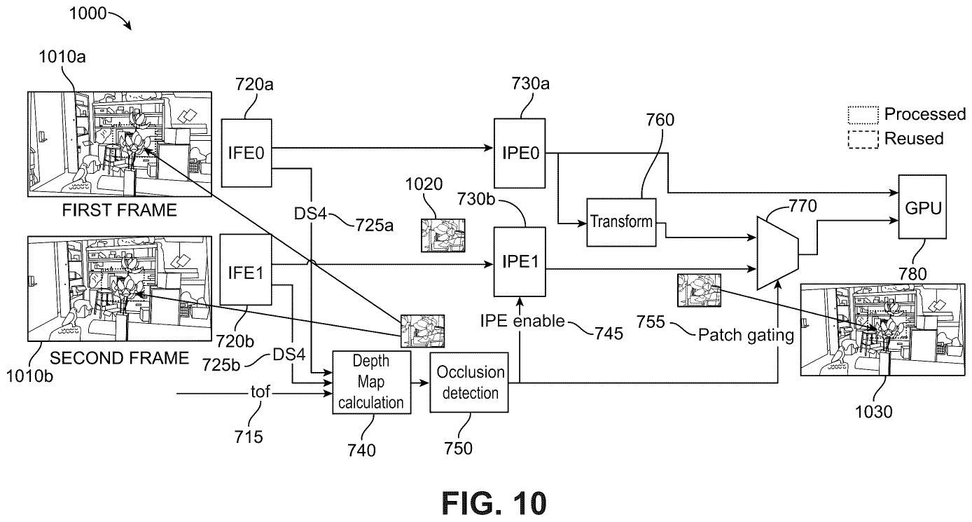

FIG. 10 is a diagram illustrating an example 1000 of operation of the system 700 of FIG. 7 for a VST solution in XR, where small areas surrounding portions including objects in the foreground are processed due to occlusion.

In one or more examples, during operation of the system 700, the first image front end (IFE0) 720a can process the first frame 1010a of the first view of the scene to generate a first image front end output, which can be input into the first image post end (IPE0) 730a. The first image post end (IPE0) 730a can process the first image front end output to generate a first image post end output (e.g., a processed first frame, also referred to as a first view output), which can be input into the GPU 780 for processing.

The second image front end (IFE1) 720b can process the second frame 1010b of the second view of the scene to generate a second image front end output 1020, which can be input into the second image post end (IPE1) 730b.

The first image front end output can be sent from the first image front end (IFE0) 720a to a depth map calculation engine 740 (e.g., including one or more processors) via the DDR 725a. Similarly, the second image front end output 1020 can be sent from the second image front end (IFE1) 720b to the depth map calculation engine 740 via the DDR 725b.

One or more processors (e.g., of the depth map calculation engine 740) can determine a depth of a portion (e.g., a region) of the scene based on the first image front end output (e.g., which is based on the first frame 1010a) and the second image front end output 1020 (e.g., which is based on the second frame 1010b).

The determined depth of the portion of the scene can be input into the overlap/occlusion detection engine 750 (e.g., including one or more processors), which can utilize the equations (1)-(8) described above to determine overlap/occlusion between frames. One or more processors (e.g., implementing the overlap/occlusion detection engine 750) can determine whether the portion of the scene is present, or overlapping, in both the first frame 1010a and the second frame 1010b (e.g., whether the portion of the scene is overlapping between the first frame 1010a and the second frame 1010b and/or whether the portion of the scene is occluded or unoccluded in the second frame 1010b relative to the first frame 1010a), based on the first image front end output (e.g., which is based on the first frame 1010a), the second image front end output 1020 (e.g., which is based on the second frame 1010b), and the determined depth of the portion of the scene.

If the one or more processors (e.g., implementing the overlap/occlusion detection engine 750) determine that the portion of the scene is not present in the first frame 1010a (e.g., not overlapping between the first frame 1010a and the second frame 1010b and/or is occluded in the second frame 1010b relative to the first frame 1010a), the one or more processors can send an IPE enable command 745 to the second image post end (IPE1) 730b commanding the second image post end (IPE1) 730b to process the second image front end output 1020 (e.g., the entire second frame as processed and output by the second image front end (IFE1) 720b). After receiving the IPE enable command 745, the second image post end (IPE1) 730b can process the second image front end output 1020 to generate a second image post end output 1030, which can be input into the multiplexer 770 for selection.

When the one or more processors (e.g., implementing the overlap/occlusion detection engine 750) determine that the portion of the scene is not present in the first frame 1010a (e.g., not overlapping between the first frame 1010a and the second frame 1010b and/or is occluded in the second frame 1010b relative to the first frame 1010a), the one or more processors can also send a patch gating command 755 to the multiplexer 770 commanding the multiplexer 770 to select and output the second image post end output 1030, which can be input (e.g., as a second view output 1030) into the GPU 780 (e.g., including one or more processors) for processing. One or more processors (e.g., the GPU 780) can process the first view output (e.g., generated by the first image post end (IPE0) 730a) and the second view output 1030 (e.g., generated by the second image post end (IPE1) 730b) to generate a composite view of the scene.

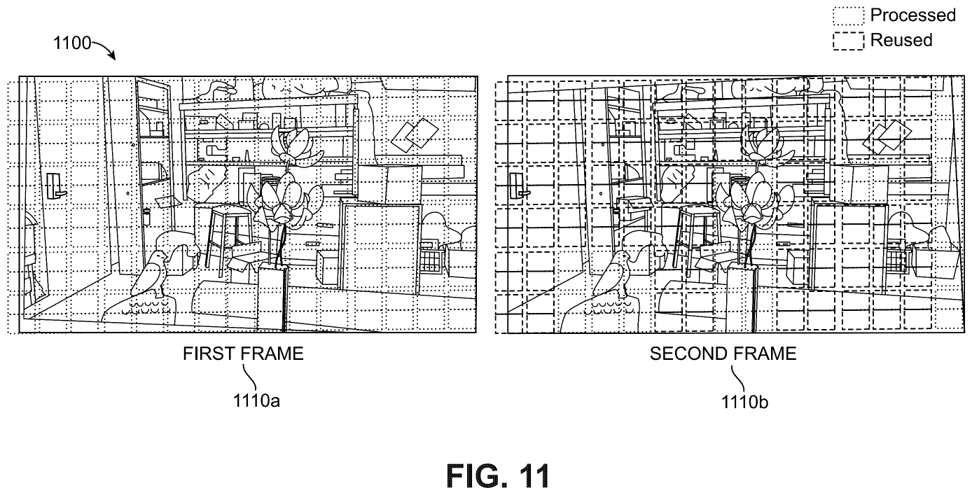

FIG. 11 is a diagram illustrating examples 1100 of portions a first frame 1110a and a second frame 1110b that are processed or reused (e.g., based on the portions overlapping between two frames and/or the portions being unoccluded in one of the frames relative to the other frame). In FIG. 11, the first frame 1110a of a scene is shown to include a plurality of portions (e.g., regions). All of these portions are designated to be processed (e.g., by IPE0) to generate a first view output for the first frame 1110a.

In FIG. 11, the second frame 1110b of the scene is shown to include a plurality of portions that are designed as “reused” such that the corresponding portions in the first frame 1110a can be reused (e.g., transformed or shifted) to generate a second view output for the second frame 1110b. These portions are designed as “reused” because they include one or more areas (e.g., objects or other area in the image) that are overlapping between the second frame 1110b and the first frame 1110a and/or that are unoccluded relative to the first frame 1110a (e.g., that can be viewed within both the first frame 1110a and the second frame 1110b).

In FIG. 11, the second frame 1110b of the scene is also shown include some portions that are designated to be processed (e.g., by IPE1) to generate a second view output for the second frame 1110b. These portions are not designated as “reused” because they include one or more objects that are not overlapping with the first frame 1110a and/or that are occluded (e.g., that cannot be viewed within the first frame 1110a).

FIG. 12 is a diagram illustrating examples 1200 of graphs 1210, 1220, 1230, 1240 showing a reduction in bandwidth and power savings by a system with two IPEs (e.g., IPE0 and IPE1) employing a VST solution in XR. In FIG. 12, for the graphs 1210, 1220, 1230, 1240, the x-axis denotes time, and the y-axis denotes IPE processing.

Graphs 1210, 1220 show the processing of IPE0 and IPE1, respectively, of a system that does not employ the VST solutions described herein (e.g., a system that does not reuse any of the portions of a scene for processing). Graphs 1230, 1240 show the processing of IPE0 and IPE1, respectively, of a system that does employ a VST solution (e.g., a system that does reuse portions of a scene for processing). As shown in FIG. 12, a system that employs a VST solution (e.g., as shown in graph 1240) requires less IPE1 processing, than a system that does not employ a VST solution (e.g., as shown in graph 1220). A system with less required IPE1 processing can have a reduction in bandwidth and power consumption.

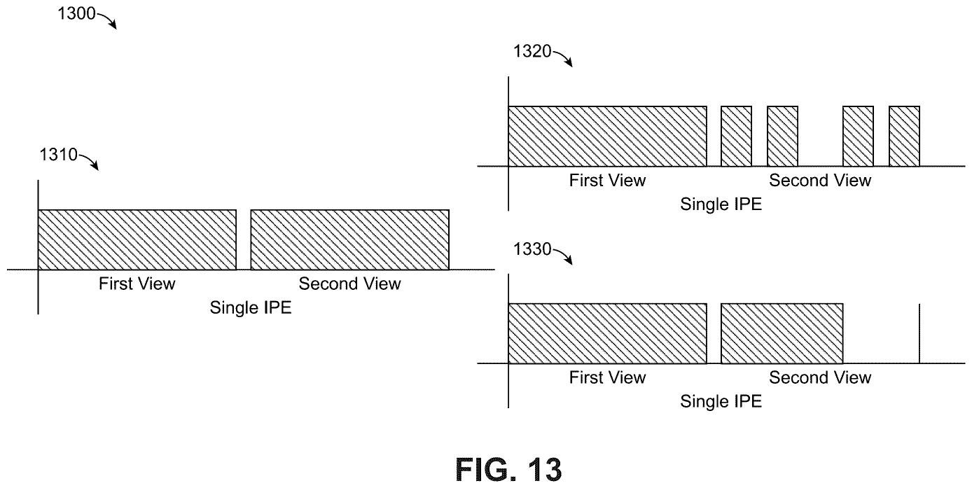

FIG. 13 is a diagram illustrating examples 1300 of graphs 1310, 1320, 1330 showing a reduction in bandwidth, power, and latency by a system with a single IPE employing a VST solution. In FIG. 13, for the graphs 1310, 1320, 1330, the x-axis denotes time, and the y-axis denotes IPE processing.

Graph 1310 shows the processing of a single IPE (e.g., for both a first frame with a first view and a second frame with a second view) of a system that does not employ a VST solution (e.g., a system that does not reuse any of the portions of a scene for processing). Graphs 1320, 1330 show the processing of a single IPE e.g., for both the first frame with a first view and the second frame with a second view) for a system that does employ a VST solution (e.g., a system that does reuse portions of a scene for processing).

As shown in FIG. 13, a system that employs a VST solution (e.g., as shown in graph 1320) requires less IPE processing for the second frame with the second view, than a system that does not employ a VST solution (e.g., as shown in graph 1310). A system with a lower amount of IPE1 processing can result in a reduction in bandwidth and power consumption.

FIG. 13 also shows that a system that employs a r VST solution (e.g., as shown in graph 1330) has a reduction in latency due to less IPE processing required for the second frame with the second view, than a system that does not employ a VST solution (e.g., as shown in graph 1310).

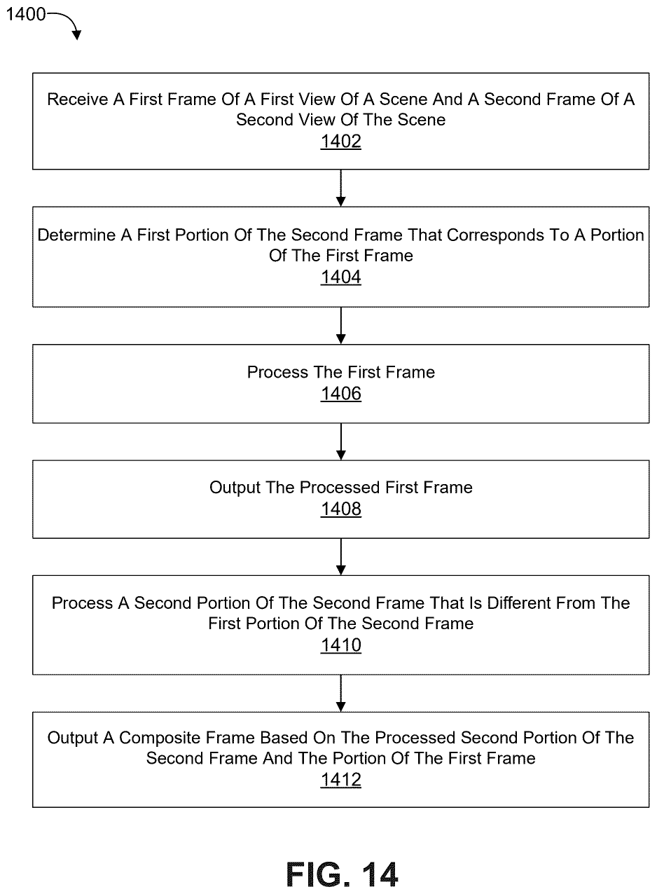

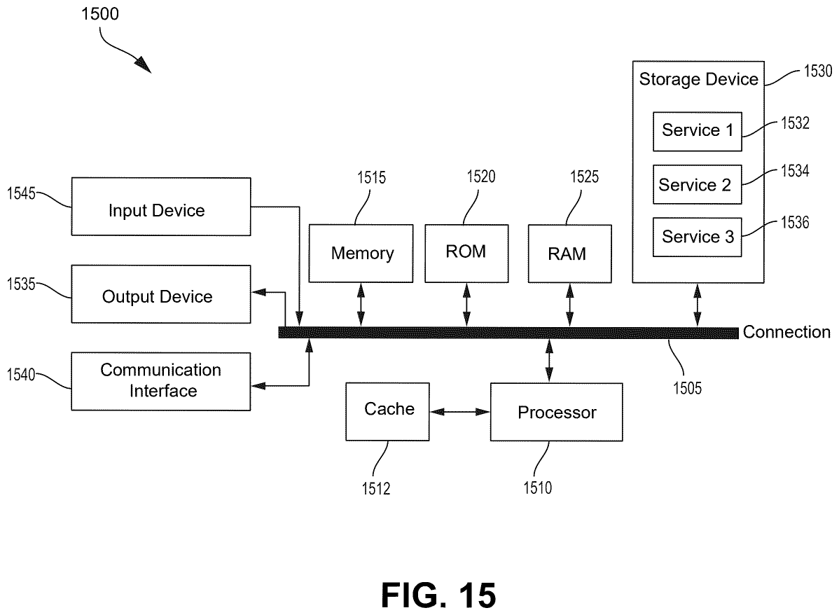

FIG. 14 is a flow chart illustrating an example of a process 1400 for image processing. The process 1400 can be performed by a computing device (e.g., a computing device or computing system 1500 of FIG. 15) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 1400 may be implemented as software components that are executed and run on one or more processors (e.g., processor 1510 of FIG. 15, or other processor(s)). Further, the transmission and reception of signals by the computing device in the process 1400 may be enabled, for example, by one or more antennas and/or one or more transceivers (e.g., wireless transceiver(s)).

At block 1402, the computing device (or component thereof) can receive a first frame of a first view of a scene and a second frame of a second view of the scene. In some aspects, a first image sensor with the first view of the scene can capture the first frame of the scene and a second image sensor with the second view of the scene can capture the second frame of the scene. In some cases, the computing device (or component thereof) can obtain the first frame from the first image sensor and can obtain the second frame from the second image sensor. In some cases, the computing device can include the first image sensor and the second image sensor. In some examples, the computing device is an extended reality (XR) headset. In such examples, the first image sensor is a left eye image sensor of the XR headset and the second image sensor is a right eye image sensor of the XR headset.

At block 1404, the computing device (or component thereof) can determine a first portion of the second frame that corresponds to a portion of the first frame (e.g., the first portion of the second frame overlaps with the portion of the first frame). In some cases, to determine the first portion of the second frame that corresponds to the portion of the first frame, the computing device (or component thereof) can determine that the first portion of the second frame overlaps with the portion of the first frame. In some aspects, the computing device (or component thereof) can determine that the first portion of the second frame overlaps with the portion of the first frame based on a depth of the scene. For instance, the computing device (or component thereof) can utilize one or more of the equations (1)-(8) described above to determine that the first portion of the second frame overlaps with the portion of the first frame.

At block 1406, the computing device (or component thereof) can process the first frame.

At block 1408, the computing device (or component thereof) can output the processed first frame.

At block 1410, the computing device (or component thereof) can process a second portion of the second frame that is different from the first portion of the second frame.

At block 1412, the computing device (or component thereof) can output a composite frame based on the processed second portion of the second frame and the portion of the first frame. For instance, the composite frame can be used for output instead of processing the full second frame due to the second frame having the first portion that corresponds to the portion of the first frame (e.g., the first portion of the second frame overlapping with the portion of the first frame). In some aspects, the computing device (or component thereof) can transform (e.g., using the transform engine 760) the portion of the first frame to the second view corresponding to the second frame to generate a transformed portion of the first frame. The computing device (or component thereof) can generate the composite frame based on the processed second portion of the second frame and the transformed portion of the first frame. In some aspects, the components of the computing device can include at least one processor, which can include an image signal processor configured to process the first frame and to process the second portion of the second frame. In some cases, the at least one processor includes a graphics processing unit (GPU) configured to process the processed first frame and the composite frame.

In some aspects, the computing device (or component thereof) can determine (e.g., using the depth map calculation engine 740) a depth of a portion of the scene (e.g., including one or more objects within the scene) based on the first frame and the second frame. The computing device (or component thereof) can determine the portion of the scene is unoccluded in the first frame based on the first frame, the second frame, and the depth of the portion of the scene. For instance, the computing device (or component thereof) can utilize one or more of the equations (1)-(8) described above to determine that the portion of the scene is unoccluded in the first frame. Based on a determination that the portion of the scene is unoccluded in the first frame, the computing device (or component thereof) can transform the portion of the scene from the first frame to the second view corresponding to the second frame to generate a transformed portion of the first frame. The computing device (or component thereof) can generate the composite frame based on the processed second portion of the second frame and the transformed portion of the first frame. In some cases, the computing device (or component thereof) can determine the depth of the portion of the scene further based on at least one of time of flight data or depth sensor data. In some examples, the computing device (or component thereof) can transform the portion of the scene from the first frame to the second view corresponding to the second frame based on at least one of the depth of the portion of the scene or using a machine learning system (e.g., a neural network).

In some cases, the computing device of process 1400 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1400 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a block diagram illustrating an example of a computing system 1500, which may be employed for a VST solution. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LiDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: receive a first frame of a first view of a scene and a second frame of a second view of the scene; determine a first portion of the second frame that corresponds to a portion of the first frame; process the first frame; output the processed first frame; process a second portion of the second frame that is different from the first portion of the second frame; and output a composite frame based on the processed second portion of the second frame and the portion of the first frame.

Aspect 2. The apparatus of Aspect 1, wherein the at least one processor is configured to: transform the portion of the first frame to the second view corresponding to the second frame to generate a transformed portion of the first frame; and generate the composite frame based on the processed second portion of the second frame and the transformed portion of the first frame.

Aspect 3. The apparatus of any of Aspects 1 or 2, wherein the at least one processor is configured to: determine a depth of a portion of the scene based on the first frame and the second frame; determine the portion of the scene is unoccluded in the first frame based on the first frame, the second frame, and the depth of the portion of the scene; based on a determination that the portion of the scene is unoccluded in the first frame, transform the portion of the scene from the first frame to the second view corresponding to the second frame to generate a transformed portion of the first frame; and generate the composite frame based on the processed second portion of the second frame and the transformed portion of the first frame.

Aspect 4. The apparatus of Aspect 3, wherein the at least one processor is configured to determine the depth of the portion of the scene further based on at least one of time of flight data or depth sensor data.

Aspect 5. The apparatus of any of Aspects 3 or 4, wherein the at least one processor is configured to transform the portion of the scene from the first frame to the second view corresponding to the second frame based on at least one of the depth of the portion of the scene or using a machine learning system.

Aspect 6. The apparatus of any of Aspects 3 to 5, wherein the portion of the scene comprises one or more objects within the scene.

Aspect 7. The apparatus of any of Aspects 1 to 6, wherein the first portion of the second frame overlaps with the portion of the first frame.

Aspect 8. The apparatus of any of Aspects 1 to 7, wherein, to determine the first portion of the second frame that corresponds to the portion of the first frame, the at least one processor is configured to determine that the first portion of the second frame overlaps with the portion of the first frame.

Aspect 9. The apparatus of Aspect 8, wherein the at least one processor is configured to determine that the first portion of the second frame overlaps with the portion of the first frame based on a depth of the scene.

Aspect 10. The apparatus of any of Aspects 1 to 9, wherein the at least one processor is configured to: obtain, by a first image sensor with the first view of the scene, the first frame of the scene; and obtain, by a second image sensor with the second view of the scene, the second frame of the scene.

Aspect 11. The apparatus of Aspect 10, wherein the first image sensor is a left eye image sensor of an extended reality (XR) headset, and the second image sensor is a right eye image sensor of the XR headset.

Aspect 12. The apparatus of any of Aspects 1 to 11, wherein the at least one processor includes an image signal processor configured to process the first frame and to process the second portion of the second frame.

Aspect 13. The apparatus of any of Aspects 1 to 12, wherein the at least one processor includes a graphics processing unit (GPU) configured to process the processed first frame and the composite frame.

Aspect 14. A method for image processing, the method comprising: receiving a first frame of a first view of a scene and a second frame of a second view of the scene; determining a first portion of the second frame that corresponds to a portion of the first frame; processing the first frame; outputting the processed first frame; processing a second portion of the second frame that is different from the first portion of the second frame; and outputting a composite frame based on the processed second portion of the second frame and the portion of the first frame.

Aspect 15. The method of Aspect 14, further comprising: transforming the portion of the first frame to the second view corresponding to the second frame to generate a transformed portion of the first frame; and generating the composite frame based on the processed second portion of the second frame and the transformed portion of the first frame.

Aspect 16. The method of any of Aspects 14 or 15, further comprising: determining a depth of a portion of the scene based on the first frame and the second frame; determining the portion of the scene is unoccluded in the first frame based on the first frame, the second frame, and the depth of the portion of the scene; based on determining the portion of the scene is unoccluded in the first frame, transforming the portion of the scene from the first frame to the second view corresponding to the second frame to generate a transformed portion of the first frame; and generating the composite frame based on the processed second portion of the second frame and the transformed portion of the first frame.

Aspect 17. The method of Aspect 16, wherein determining the depth of the portion of the scene is further based on at least one of time of flight data or depth sensor data.

Aspect 18. The method of any of Aspects 16 or 17, wherein transforming the portion of the scene from the first frame to the second view corresponding to the second frame is based on at least one of the depth of the portion of the scene or using a machine learning system.

Aspect 19. The method of any of Aspects 16 to 18, wherein the portion of the scene comprises one or more objects within the scene.

Aspect 20. The method of any of Aspects 14 to 19, wherein the first portion of the second frame overlaps with the portion of the first frame.

Aspect 21. The method of any of Aspects 14 to 20, wherein determining the first portion of the second frame that corresponds to the portion of the first frame comprises determining that the first portion of the second frame overlaps with the portion of the first frame.

Aspect 22. The method of Aspect 21, wherein determining that the first portion of the second frame overlaps with the portion of the first frame is based on a depth of the scene.

Aspect 23. The method of any of Aspects 14 to 22, further comprising: obtaining, by a first image sensor with the first view of the scene, the first frame of the scene; and obtaining, by a second image sensor with the second view of the scene, the second frame of the scene.

Aspect 24. The method of Aspect 23, wherein the first image sensor is a left eye image sensor of an extended reality (XR) headset, and the second image sensor is a right eye image sensor of the XR headset.

Aspect 25. The method of any of Aspects 14 to 24, wherein processing the first frame and processing the second portion of the second frame is performed by an image signal processor.

Aspect 26. The method of any of Aspects 14 to 25, further comprising processing the processed first frame and the composite frame using a graphics processing unit (GPU).

Aspect 27. A non-transitory computer-readable medium having stored thereon instructions that, when executed by at least one processor, cause the at least one processor to perform operations according to any of Aspects 14 to 26.

Aspect 28. An apparatus for generating virtual content in a distributed system, the apparatus including one or more means for performing operations according to any of Aspects 14 to 26.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
receive a first frame of a first view of a scene and a second frame of a second view of the scene;
determine a first portion of the second frame that corresponds to a portion of the first frame;
process the first frame;
output the processed first frame;
process a second portion of the second frame that is different from the first portion of the second frame; and
output a composite frame based on the processed second portion of the second frame and the portion of the first frame.

2. The apparatus of claim 1, wherein the at least one processor is configured to:
transform the portion of the first frame to the second view corresponding to the second frame to generate a transformed portion of the first frame; and
generate the composite frame based on the processed second portion of the second frame and the transformed portion of the first frame.

3. The apparatus of claim 1, wherein the at least one processor is configured to:
determine a depth of a portion of the scene based on the first frame and the second frame;
determine the portion of the scene is unoccluded in the first frame based on the first frame, the second frame, and the depth of the portion of the scene;
based on a determination that the portion of the scene is unoccluded in the first frame, transform the portion of the scene from the first frame to the second view corresponding to the second frame to generate a transformed portion of the first frame; and
generate the composite frame based on the processed second portion of the second frame and the transformed portion of the first frame.

4. The apparatus of claim 3, wherein the at least one processor is configured to determine the depth of the portion of the scene further based on at least one of time of flight data or depth sensor data.

5. The apparatus of claim 3, wherein the at least one processor is configured to transform the portion of the scene from the first frame to the second view corresponding to the second frame based on at least one of the depth of the portion of the scene or using a machine learning system.

6. The apparatus of claim 3, wherein the portion of the scene comprises one or more objects within the scene.

7. The apparatus of claim 1, wherein the first portion of the second frame overlaps with the portion of the first frame.

8. The apparatus of claim 1, wherein, to determine the first portion of the second frame that corresponds to the portion of the first frame, the at least one processor is configured to determine that the first portion of the second frame overlaps with the portion of the first frame.

9. The apparatus of claim 8, wherein the at least one processor is configured to determine that the first portion of the second frame overlaps with the portion of the first frame based on a depth of the scene.

10. The apparatus of claim 1, wherein the at least one processor is configured to:
obtain, by a first image sensor with the first view of the scene, the first frame of the scene; and
obtain, by a second image sensor with the second view of the scene, the second frame of the scene.

11. The apparatus of claim 10, wherein the first image sensor is a left eye image sensor of an extended reality (XR) headset, and the second image sensor is a right eye image sensor of the XR headset.

12. The apparatus of claim 1, wherein the at least one processor includes an image signal processor configured to process the first frame and to process the second portion of the second frame and a graphics processing unit (GPU) configured to process the processed first frame and the composite frame.

13. A method for image processing, the method comprising:
receiving a first frame of a first view of a scene and a second frame of a second view of the scene;
determining a first portion of the second frame that corresponds to a portion of the first frame;
processing the first frame;
outputting the processed first frame;
processing a second portion of the second frame that is different from the first portion of the second frame; and
outputting a composite frame based on the processed second portion of the second frame and the portion of the first frame.

14. The method of claim 13, further comprising:
transforming the portion of the first frame to the second view corresponding to the second frame to generate a transformed portion of the first frame; and
generating the composite frame based on the processed second portion of the second frame and the transformed portion of the first frame.

15. The method of claim 13, further comprising:
determining a depth of a portion of the scene based on the first frame and the second frame;
determining the portion of the scene is unoccluded in the first frame based on the first frame, the second frame, and the depth of the portion of the scene;
based on determining the portion of the scene is unoccluded in the first frame, transforming the portion of the scene from the first frame to the second view corresponding to the second frame to generate a transformed portion of the first frame; and
generating the composite frame based on the processed second portion of the second frame and the transformed portion of the first frame.

16. The method of claim 15, wherein determining the depth of the portion of the scene is further based on at least one of time of flight data or depth sensor data.

17. The method of claim 15, wherein transforming the portion of the scene from the first frame to the second view corresponding to the second frame is based on at least one of the depth of the portion of the scene or using a machine learning system.

18. The method of claim 13, wherein the first portion of the second frame overlaps with the portion of the first frame.

19. The method of claim 13, wherein determining the first portion of the second frame that corresponds to the portion of the first frame comprises determining that the first portion of the second frame overlaps with the portion of the first frame.

20. The method of claim 19, wherein determining that the first portion of the second frame overlaps with the portion of the first frame is based on a depth of the scene.
